(19) United States
(12) Patent Application Publication
(10) Pub. No.: US 2018/0258234 A1
(43) Pub. Date: Sep. 13, 2018

(54) SOLVENT, SOLUTION, AND MANUFACTURING METHOD FOR ALIGNMENT FILM

(71) Applicant: Shenzhen China Star Optoelectronics Technology Co., Ltd., Shenzhen, Guangdong (CN)

(72) Inventor: Wei REN, Shenzhen, Guangdong (CN)

(73) Assignee: Shenzhen China Star Optoelectronics Technology Co., Ltd., Shenzhen, Guangdong (CN)

(21) Appl. No.: 15/323,459

(22) PCT Filed: Aug. 17, 2016
(86) PCT No.: PCT/CN2016/095771

§ 371 Date: Jan. 3, 2017

(30) Foreign Application Priority Data
Jul. 13, 2016 (CN) 201610554239.2

(51) Int. Cl. C08J 3/09; C08J 5/18; C08L 79/08; G02F 1/1337

(52) U.S. Cl. CPC C08J 3/09; C08J 5/18; C08J 2379/08; G02F 1/133723; C08L 79/08

(57) ABSTRACT

The present disclosure provides a solvent for alignment film material including 1-Methyl-2-pyrrolidinone, 2-Butoxyethanol, and 1,2-diethoxy-ethan. The present disclosure also provides an alignment film solution and a manufacturing method for alignment film. Through the present disclosure, the uniformity of the alignment film solution's coating is enhanced.

### BACKGROUND OF THE INVENTION

### 1. Field of the Invention

The present disclosure generally relates to display techniques, and particularly relates to a solvent, a solution, and a manufacturing method for alignment film.

### 2. The Related Arts

As the market continuously demands display panels of even greater resolutions, and in order to achieve even better viewing angles, Fringe Field Switching (FFS) alignment techniques are gaining maturity. For thin-film transistor array substrates of high resolutions (e.g., 8K, 4K, or above 400 ppi), their patterns are more complex, pixel dimensions are smaller, line widths and vias are narrower. The fluidity of polyimide (PI) solution (for manufacturing the alignment film) used in Cell techniques would be affected by the more complex patterns, and the un-uniform coating of the PI solution would lead to inferior display quality. Especially when vias are of smaller apertures, the PI solution may not flow into the vias and some vias are not covered by the PI solution.

To address the above technical issue, the alignment film requires improved solvent, solution, and manufacturing method.

### SUMMARY OF THE INVENTION

The technical issue addressed by the present disclosure is to enhance the uniformity of an alignment film solution's coating on a substrate by providing a solvent for alignment film material, a solution for alignment film, and a manufacturing method for alignment film.

The present disclosure teaches a solvent for alignment film material including 1-Methyl-2-pyrrolidinone, 2-Butoxyethanol, and 1,2-diethoxy-ethan.

The content of the 1-Methyl-2-pyrrolidinone is no more than 50%, the content of the 2-Butoxyethanol is between 35% and 45%, and the content of 1,2-diethoxy-ethan is between 5%-15%, of the solvent.

The solvent's surface tension is no more than 27 dyne/cm2.

The present disclosure also teaches a solution for alignment film including a solvent and an alignment film material dissolved in the solvent. The solvent comprises 1-Methyl-2-pyrrolidinone, 2-Butoxyethanol, and 1,2-diethoxy-ethan.

The content of the 1-Methyl-2-pyrrolidinone is no more than 50%, the content of the 2-Butoxyethanol is between 35% and 45%, and the content of 1,2-diethoxy-ethan is between 5%-15%, of the solvent.

The solvent's surface tension is no more than 27 dyne/cm2.

The alignment film material is polyimide.

The present disclosure also teaches a manufacturing method for alignment film and includes the following steps: providing a solvent including 1-Methyl-2-pyrrolidinone, 2-Butoxyethanol, 1,2-diethoxy-ethan; obtaining a solution for alignment film by dissolving an alignment film material in the solvent; coating the solution on a substrate; waiting for a preset period of time so that the solution fully flows on the substrate; and forming an alignment film on the substrate by curing the substrate and the solution.

The content of the 1-Methyl-2-pyrrolidinone is no more than 50%, the content of the 2-Butoxyethanol is between 35% and 45%, and the content of 1,2-diethoxy-ethan is between 5%-15%, of the solvent.

The solvent's surface tension is no more than 27 dyne/cm2.

The preset period of time is between 1 to 2 minutes.

The substrate includes vias of depth between 2.5 to 3 um with bottom apertures between 5 and 8 um. The solution fully flows on the substrate when the solution is uniform on the substrate and fully fills the vias.

The advantage of the present disclosure is as follows. The present embodiment provides a solvent for alignment film by combining 1-Methyl-2-pyrrolidinone, 2-Butoxyethanol, and 1,2-diethoxy-ethan so as to reduce the solvent's surface tension, thereby effectively enhancing the coatability and fluidity of a solution for alignment film. Especially when there are fine vias on the thin film transistor (TFT) array substrate, the enhancement is more obvious.

### BRIEF DESCRIPTION OF THE DRAWINGS

To make the technical solution of the embodiments according to the present disclosure, a brief description of the drawings that are necessary for the illustration of the embodiments will be given as follows. Apparently, the drawings described below show only example embodiments of the present disclosure and for those having ordinary skills in the art, other drawings may be easily obtained from these drawings without paying any creative effort. In the drawings:

FIG. 1 is a flow diagram showing a manufacturing method for alignment film according to an embodiment of the present disclosure.

### DETAILED DESCRIPTION OF THE PREFERRED EMBODIMENTS

### Embodiment 1 of a Solvent for Alignment Film

The solvent includes 1-Methyl-2-pyrrolidinone, 2-Butoxyethanol, and 1,2-diethoxy-ethan.

For the solvent, the content of the 1-Methyl-2-pyrrolidinone is no more than 50%, the content of the 2-Butoxyethanol is between 35% and 45%, and the content of 1,2-diethoxy-ethan is between 5%-15%. The above “content” refers to mass percent, the percentage of the component's mass to the solvent's total mass.

In alternative embodiments, the solvent may also include γ-Butyrolactone.

1-Methyl-2-pyrrolidinone is also called NMP, N-Methyl-2-pyrrolidone, N-Methylpyrrolidone; N-Methylpyrrolidinone.

2-Butoxyethanol is also called BC.

1,2-diethoxy-ethan is also called Ethene, 1,2-diethoxy-(9CI).

γ-Butyrolactone is also called GBL.

Preferably, the solvent has a surface tension no more than 27 dyne/cm2.

In other words, the present embodiment provides a solvent by combining 1-Methyl-2-pyrrolidinone, 2-Butoxyethanol, and 1,2-diethoxy-ethan so as to reduce the solvent's surface tension, thereby effectively enhancing the coatability and fluidity of a solution for alignment film. Especially when there are fine vias on the thin film transistor (TFT) array substrate, the enhancement is more obvious. In the solvent, the contents of the 1-Methyl-2-pyrrolidinone, the 2-Butoxyethanol, and the 1,2-diethoxy-ethan are no more than 50%, between 35% and 45%, and between 5%-15%, respectively, and the solvent's surface tension is no more than 27 dyne/cm2.

### Embodiment 2 of a Solvent for Alignment Film

The solvent includes 1-Methyl-2-pyrrolidinone, 2-Butoxyethanol, 1,2-diethoxy-ethan, and γ-Butyrolactone.

For the solvent, the content of the 1-Methyl-2-pyrrolidinone is 1%, the content of the 2-Butoxyethanol is 35%, the content of 1,2-diethoxy-ethan is 5%, and the content of the γ-Butyrolactone is 59%. The above “content” refers to mass percent, the percentage of the component's mass to the solvent's total mass.

The solvent's surface tension is measure to be 19.87 dyne/cm2 using the maximum bubble method.

### Embodiment 3 of a Solvent for Alignment Film

The solvent includes 1-Methyl-2-pyrrolidinone, 2-Butoxyethanol, 1,2-diethoxy-ethan, and γ-Butyrolactone.

For the solvent, the content of the 1-Methyl-2-pyrrolidinone is 25%, the content of the 2-Butoxyethanol is 40%, the content of 1,2-diethoxy-ethan is 10%, and the content of the γ-Butyrolactone is 25%. The above “content” refers to mass percent, the percentage of the component's mass to the solvent's total mass.

The solvent's surface tension is measure to be 14.68 dyne/cm2 using the maximum bubble method.

### Embodiment 4 of a Solvent for Alignment Film

The solvent includes 1-Methyl-2-pyrrolidinone, 2-Butoxyethanol, and 1,2-diethoxy-ethan.

For the solvent, the content of the 1-Methyl-2-pyrrolidinone is 50%, the content of the 2-Butoxyethanol is 45%, and the content of 1,2-diethoxy-ethan is 5%. The above “content” refers to mass percent, the percentage of the component's mass to the solvent's total mass.

The solvent's surface tension is measure to be 12.73 dyne/cm2 using the maximum bubble method.

### Embodiment 5 of a Solvent for Alignment Film

The solvent includes 1-Methyl-2-pyrrolidinone, 2-Butoxyethanol, 1,2-diethoxy-ethan, and γ-Butyrolactone.

For the solvent, the content of the 1-Methyl-2-pyrrolidinone is 50%, the content of the 2-Butoxyethanol is 35%, and the content of 1,2-diethoxy-ethan is 15%. The above “content” refers to mass percent, the percentage of the component's mass to the solvent's total mass.

The solvent's surface tension is measure to be 13.56 dyne/cm2 using the maximum bubble method.

Please refer to Table 1 which summarizes the contents and surface tensions of the solvents according embodiments 2 to 5.

| | Embodi- | Embodi- | Embodi- | Embodi- |
|---|---|---|---|---|
| | ment 2 | ment 3 | ment 4 | ment 5 |
| 1-Methyl-2-pyrrolidinone | 1% | 25% | 50% | 50% |
| 2-Butoxyethanol | 35% | 40% | 45% | 35% |
| 1,2-diethoxy-ethan | 5% | 10% | 5% | 15% |
| γ-Butyrolactone | 59% | 25% | — | — |
| Surface tension | 19.87 | 14.68 | 12.73 | 13.56 |
| | dyne/cm2 | dyne/cm2 | dyne/cm2 | dyne/cm2 |

The solvent of the second embodiment has less 1-Methyl-2-pyrrolidinone, 2-Butoxyethanol, and 1,2-diethoxy-ethan, but more γ-Butyrolactone. The measured surface tension is 19.87 dyne/cm2, which is larger than those of the other embodiments and therefore its fluidity is inferior. However this fluidity still meets requirement. The advantage of the solvent of the second embodiment is its cost as γ-Butyrolactone is less costly than 1-Methyl-2-pyrrolidinone while the fluidity is still acceptable.

The solvent of the third embodiment has 1-Methyl-2-pyrrolidinone, 2-Butoxyethanol, 1,2-diethoxy-ethan, and γ-Butyrolactone of medium levels. The measured surface tension is 14.68 dyne/cm2, which is smaller than that of the second embodiment and therefore a superior fluidity is achieved. The cost however is higher. The advantage of the solvent of the third embodiment is that it strikes a balance between cost and fluidity, thereby providing a better performance.

The solvent of the fourth embodiment has more 1-Methyl-2-pyrrolidinone and 2-Butoxyethanol, but least 1,2-diethoxy-ethan. The measured surface tension is 12.73 dyne/cm2, which is the greatest among the embodiments and therefore a best fluidity is achieved. The cost however is also the highest. The advantage of the solvent of the fourth embodiment is therefore its fluidity.

The solvent of the fifth embodiment has more 1-Methyl-2-pyrrolidinone, medium-level 2-Butoxyethanol, and also more 1,2-diethoxy-ethan. The measured surface tension is 13.56 dyne/cm2, which is slightly higher than that of the fourth embodiment and therefore a less fluidity is achieved. The cost however is lower than the fourth embodiment.

The present disclosure also teach a solution for alignment film which includes a solvent and an alignment film material dissolved in the solvent. The solvent is one of the solvents described above.

The alignment film material is preferably polyimide or, more preferably, polyimide having ultra-violet photosensitive group.

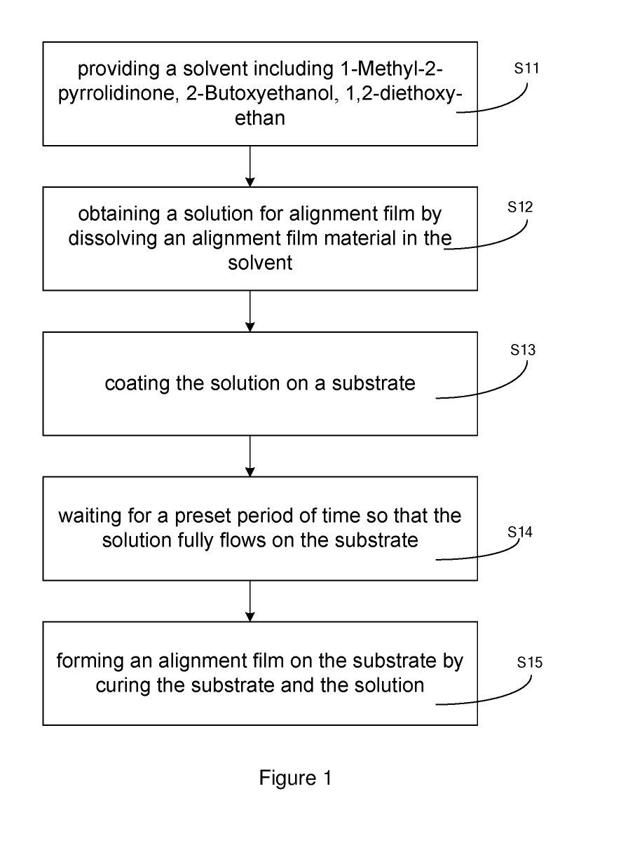

FIG. 1 is a flow diagram showing a manufacturing method for alignment film according to an embodiment of the present disclosure. The manufacturing method includes the following steps.

Step S11: providing a solvent including 1-Methyl-2-pyrrolidinone, 2-Butoxyethanol, 1,2-diethoxy-ethan.

In step S11, for the solvent, the contents of the 1-Methyl-2-pyrrolidinone, the 2-Butoxyethanol, and the 1,2-diethoxy-ethan are no more than 50%, between 35% and 45%, and between 5%˜15%, respectively, and the solvent's surface tension is no more than 27 dyne/cm2. the solvent may also include γ-Butyrolactone. For more details, please see the above description to the solvent's various embodiments.

Step S12: Obtaining a solution for alignment film by dissolving an alignment film material in the solvent.

In step S12, the alignment film material is preferably polyimide or, more preferably, polyimide having ultra-violet photosensitive group.

Step S13: coating the solution on a substrate.

In step S13, the solution is coated using inkjet method. Preferably, the substrate is a thin film transistor (TFT) array substrate.

Step S14: waiting for a preset period of time so that the solution fully flows on the substrate.

In step S14, the preset period of time is between 1 to 2 minutes. The substrate includes vias of depth between 2.5 to 3 um with bottom apertures between 5 and 8 um. The solution fully flows on the substrate when the solution is uniform on the substrate and fully fills the vias.

Step S15: forming an alignment film on the substrate by curing the substrate and the solution.

In step S15, the curing of the substrate and the solution includes pre-curing and post-curing.

In summary, the present disclosure provides a solvent by combining 1-Methyl-2-pyrrolidinone, 2-Butoxyethanol, and 1,2-diethoxy-ethan so as to reduce the solvent's surface tension, thereby effectively enhancing the coatability and fluidity of a solution for alignment film. Especially when there are fine vias on the thin film transistor (TFT) array substrate, the enhancement is more obvious.

Embodiments of the present disclosure have been described, but not intending to impose any unduly constraint to the appended claims. Any modification of equivalent structure or equivalent process made according to the disclosure and drawings of the present disclosure, or any application thereof, directly or indirectly, to other related fields of technique, is considered encompassed in the scope of protection defined by the claims of the present disclosure.

What is claimed is:

1. A solvent for alignment film material, comprising 1-Methyl-2-pyrrolidinone, 2-Butoxyethanol, and 1,2-diethoxy-ethan.

2. The solvent as claimed in claim 1, wherein the content of the 1-Methyl-2-pyrrolidinone is no more than 50%, the content of the 2-Butoxyethanol is between 35% and 45%, and the content of 1,2-diethoxy-ethan is between 5%˜15%, of the solvent.

3. The solvent as claimed in claim 1, wherein the solvent's surface tension is no more than 27 dyne/cm2.

4. A solution for alignment film, comprising a solvent and an alignment film material dissolved in the solvent, wherein the solvent comprises 1-Methyl-2-pyrrolidinone, 2-Butoxyethanol, and 1,2-diethoxy-ethan.

5. The solution as claimed in claim 4, wherein the content of the 1-Methyl-2-pyrrolidinone is no more than 50%, the content of the 2-Butoxyethanol is between 35% and 45%, and the content of 1,2-diethoxy-ethan is between 5%˜15%, of the solvent.

6. The solvent as claimed in claim 4, wherein the solvent's surface tension is no more than 27 dyne/cm2.

7. The solvent as claimed in claim 4, wherein alignment film material is polyimide.

8. A manufacturing method for alignment film, comprising
providing a solvent including 1-Methyl-2-pyrrolidinone, 2-Butoxyethanol, 1,2-diethoxy-ethan;
obtaining a solution for alignment film by dissolving an alignment film material in the solvent;
coating the solution on a substrate;
waiting for a preset period of time so that the solution fully flows on the substrate; and
forming an alignment film on the substrate by curing the substrate and the solution.

9. The method as claimed in claim 8, wherein the content of the 1-Methyl-2-pyrrolidinone is no more than 50%, the content of the 2-Butoxyethanol is between 35% and 45%, and the content of 1,2-diethoxy-ethan is between 5%˜15%, of the solvent.

10. The method as claimed in claim 8, wherein the solvent's surface tension is no more than 27 dyne/cm2.

11. The method as claimed in claim 8, wherein the preset period of time is between 1 to 2 minutes.

12. The method as claimed in claim 8, wherein the substrate comprises vias of depth between 2.5 to 3 um with bottom apertures between 5 and 8 um; and the solution fully flows on the substrate when the solution is uniform on the substrate and fully fills the vias.
